(19) United States
(12) Patent Application Publication
(10) Pub. No.: US 2017/0087961 A1
(43) Pub. Date: Mar. 30, 2017

(54) AIR CONDITIONER

(71) Applicant: AURORA Konrad G. Schulz GmbH & Co. KG, Mudau (DE)

(72) Inventors: Ralf Kern, Walldurn (DE); Hannes Wolf, Buchen (DE); Joern Pieper, Buchen (DE)

(21) Appl. No.: 15/236,411

(22) Filed: Aug. 13, 2016

(30) Foreign Application Priority Data
Aug. 17, 2015 (DE) 102015113544.2

(51) Int. Cl. B60H 1/32; B60H 1/00

(52) U.S. Cl. CPC B60H 1/3233; B60H 1/00542; B60H 1/00521; B60H 1/00335; B60H 1/00328

(57) ABSTRACT

An air conditioning unit includes one or more evaporators and the one or more heat exchangers consisting of flat tubes made of light metal. At least one of the heat exchangers, at least one of the evaporators, at least two of the condensed water tanks and at least one of the fans for the one or more evaporators and/or heat exchangers together form one module and are surrounded by a housing. The condensed water tanks are arranged in transverse alignment relative to one another in the module, in order to collect condensed water and can be adapted to various mounting positions of the module. The compressor and/or the expansion valve, respectively, are interchangeable to adapt to various performance requirements of the evaporators. The performance of the fans is changeable to adapt to performance requirements of the evaporators, or the fans are interchangeable.

### CROSS-REFERENCE TO RELATED APPLICATIONS

The instant application claims the priority date of Aug. 17, 2015, the filing date of the German patent application DE 10 2015 113 544.2.

### BACKGROUND OF THE INVENTION

The invention relates to an air conditioning unit.

Air conditioning units are currently used not only in buildings, but also in vehicles, such as in cabins of machines, for example. An air conditioning unit of this type is intended to meet various requirements in vehicles, such as the supply of fresh air and the heating/cooling of the indoor air, for example. Moreover, it should be possible for the air conditioning unit to ventilate, heat and cool specifically determined areas of vehicles. For example, it should be possible for this type of air conditioning unit to selectively heat the foot space or leg area or to defrost the windowpanes.

Various types of machines with cabins of various sizes require different air conditioning unit performances. For example, a backhoe loader with a larger cabin is designed for an evaporator performance of approximately 6 kW, and a mini excavator with a relatively smaller cabin is designed for only approximately 3.6 kW.

Thus, different air conditioning units with various performances must to be employed in machines depending on the performance requirement.

The mounting locations of air conditioning units in machines also differ from each other according to the structural design of cabins and the practical needs. An air conditioning unit of this type can be attached or installed, respectively, behind or under the seat, at the sidewall or under the instrument panel.

Accordingly, it is necessary to use different air conditioning units.

With regard to the weight, copper pipes of heat exchangers and evaporators of air conditioning units in vehicles have been replaced by aluminum pipes in recent years. Round pipes made of aluminum may have approximately 20% less weight than pipes made of copper.

Attempts are always made to not only further reduce the total weight, but also the total size of an air conditioning unit for vehicles while offering the same performance. For example, a powerful air conditioning unit can be employed in a small vehicle. Moreover, a smaller air conditioning unit interferes less with other components in the vehicle.

Therefore, the invention is based on the object of producing an air conditioning unit that can be used for cabins of machines and can be constructed with a design that is as compact and lightweight as possible, and which can be adapted to typical mounting situations and used in a flexible and universal manner, in particular in cabins of different machines.

### SUMMARY OF THE INVENTION

The air conditioning unit according to the present invention surprisingly is able to better collect condensed water at construction sites than a conventional air conditioning unit, and is then able to avoid a possible contamination of the cabins of machines and can thus remain functional for a longer period of time.

If machines are employed on construction sites, the road surfaces of which are usually uneven, the air conditioning unit often inclines or tilts with the machines. A conventional air conditioning unit normally accommodates its condensed water tank beneath the evaporator. If the air conditioning unit, namely the evaporator, inclines or tilts, there is the danger that a portion of the condensed water is not collected by the condensed water tank. This portion of the condensed water flows within the air conditioning unit and/or as the case may be, escapes or pours out therefrom and then flows along the inner wall or the back side of the seat to the floor of the cabins.

Because the air conditioning according to the present invention includes at least two condensed water tanks—or perhaps three, or four, or five that are arranged in transverse alignment relative to one another—this danger is surprisingly readily avoided. The condensed water that is not collected by the first condensed water tank due to the inclination or tilting of the evaporator is collected by one or more other condensed water tanks.

In this manner, the entire amount of condensed water is collected during the operation of machines on construction sites. Potential corrosion of air conditioning unit components due to the humidity that is caused by uncollected condensed water, as well as potential of the cabin, is avoided.

Compared to the commonly utilized round pipe, the flat pipe can be arranged more compactly due to its rectangular shape. Heat exchangers with flat pipes therefore have a significantly higher power density. For this reason, the air conditioning unit with flat pipes according to the present invention can be constructed to be more lightweight and smaller than an air conditioning unit with round pipes in the case of the equal performance.

The flat pipes of the evaporator and heat exchanger of the air conditioning unit consist of light metal, preferably aluminum, rather than copper, and for this reason reduce the total weight.

The height-to-width-ratio of the flat pipe of the one or more heat exchangers amounts to approximately 1:20, in particular 1:10, preferably approximately 1:5.

The evaporator and heat exchanger of the inventive air conditioning unit comprise plate fins for heat transfer of the air passing through, the plate fins consisting of aluminum, in particular.

The flat pipes are arranged on top of each other and parallel to one another and the plate fins together extend between the flat pipes in a quasi “W”-shape or “U”-shape in an upright or inclined manner. Water passes through the flat pipes, and air through the plate fins, wherein the directions of flow of water and air are approximately perpendicular to one another on the horizontal plane.

According to the invention, at least one of the heat exchangers, at least one of the evaporators, at least two of the condensed water tanks and at least one of the fans for the one or more evaporators and/or heat exchangers together form one module. The components of this module are surrounded by one of the housings.

The air inflow or intake sides of the one or more heat exchangers and the one or more evaporators are parallel to one another. The heights of the heat exchanger and of the evaporator are approximately equal and approximately 20% larger than the height of the fan for the evaporator and/or the heat exchanger.

During heating and cooling, the evaporator and heat exchanger each implement a circulated air operation or a heating operation, respectively, in the cabin of machines. The two heat exchangers with their corresponding fans and condensed water tanks are modularized according to the invention, thus simplifying maintenance and exchange.

The inventive module in particular has a cooling capacity and a heating capacity between approximately 4 kW and approximately 8 kW, or between approximately 8 kW and approximately 12 kW, respectively, preferably between approximately 5 kW and approximately 7 kW or between 9.5 kW and approximately 11 kW, respectively.

A module according to the invention has a length of 250 mm to 350 mm, a thickness of 320 mm to 460 mm, and a height of 130 mm to 200 mm.

The modularized design is advantageous for the purpose of maintenance and exchange. Only the respective module is serviced and (partially) exchanged without interfering with the remaining components of the inventive air conditioning unit.

According to the invention, at least two condensed water tanks are provided in the module that are arranged in transverse alignment relative to one another in order be able to collect all condensed water at various mounting situations of the inventive air conditioning unit, such as upright behind the seats, lying under the seats, inclined towards the side walls and under an instrument panel.

In a preferred embodiment, it is provided that in the module, at least one of the condensed water tanks is arranged at one of the face sides and/or one of the closed sides of the one or more evaporators. The area of the one or more condensed water tanks is slightly larger than the area of the front face and/or the closed side of the one or more evaporators.

In a further preferred embodiment, it is provided that at least one of the condensed water tanks is arranged with spacing or distance at the air outflow side of the one or more evaporators in the module, the distance in particular amounting to three times to five times the width of the one or more evaporators, such that the air resistance is not unintentionally too large due to a condensed water tank that is arranged too close. The area of the one or more condensed water tanks is significantly larger than that of the air outflow side of the one or more evaporators. This ensures that the entire volume of condensed water, with a relatively large distance to the condensed water tank, can be collected by the larger condensed water tank.

For example, if the inventive air conditioning unit is employed in a smaller cabin of machines, which requires a smaller power, the compressor and/or the expansion valve and/or the fan for the one or more evaporators and/or the one or more heat exchangers are exchangeable according to the invention.

According to the invention, the power or performance of said fans is changeable by means of a pulse width modulation in adaptation to the requirements.

In a preferred embodiment it is provided that in the event of a smaller energy requirement, the evaporator and/or heat exchanger within the module can be exchanged for a smaller evaporator and/or heat exchanger, wherein the smaller evaporator and/or heat exchanger in particular has/have the same height and width as the exchanged evaporator and/or heat exchanger, but also a shorter length than the exchanged evaporator and/or heat exchanger.

In a preferred embodiment it is provided that at least one rotatable flap, which is driven by a motor, is disposed at the module, by means of which of which the air stream is switchable between fresh air and circulating air. The flap or flaps has/have approximately the same length as compared to the one or more heat exchangers or evaporators.

The longitudinal side of the flap or flaps in case of fresh air or circulating air forms an angle with the air inflow side of the one or more heat exchangers or the one or more evaporators. The angle is between 30 which angle in particular is 30 to 60.

In a different preferred embodiment, in which the flap or flaps is/are longer, it is provided that at least one ridge extends along the longitudinal axis of the longitudinal side of the one or more flaps approximately perpendicular to the one or more flaps and is connected therewith. The one or more ridges has/have approximately the same length and half the width than of the one ore more flaps and reinforce the one or more long flaps.

In a preferred embodiment, it is provided that an air intake case is provided at the module and is connected therewith in a manner known per se in a sealed manner, in particular with the aid of a flange. The inventive air intake case comprises at least two connecting pieces or sockets that in particular each are arranged approximately at the center of an area of the air intake case, and wherein with the aid of the sockets or flanges the inlet of recirculating air or fresh air may be connected.

In another preferred embodiment the above-mentioned sockets are exchangeable by flanges in a manner known per se.

In one embodiment, the inventive one or more flaps is/are arranged within the air intake case.

In a preferred embodiment it is provided that at least one condensed water tank is disposed at the one or more flaps. The one ore more flaps is/are are arranged between the one or more evaporators and the one ore more condensed water tanks, and the area of the one or more condensed water tanks is significantly larger than that of the air outflow side of the one or more evaporators. This ensures that the entire condensed water can be collected.

In a preferred embodiment, it is provided that the one ore more heat exchangers or evaporators are disposed in the direction of air flow between the fans for the one or more evaporators and/or the one or more heat exchangers and the one or more flaps. In this case, the fans draw in the air that flows through the one or more evaporators and/or the one or more heat exchangers and conduct it or deliver it to air distribution elements.

In another preferred embodiment it is provided that the fans for the one or more heat exchangers or the one or more evaporators are arranged in the air flow direction between the one or more evaporators and/or the one or more heat exchangers and the one or more flaps. In this case the fans draw in the air that flows through the one or more evaporators and/or the one or more heat exchangers and deliver it towards the one ore more evaporators and/or the one or more heat exchangers.

The height of the exhaust opening of the exhaust channel of the fans is approximately ⅔, in particular approximately ½, of the height of the one or more evaporators and/or the one or more heat exchangers.

According to the invention, the cross-sectional area of the exhaust channel of the fans enlarges in the direction towards the exhaust opening such that the discharged air flows through an area as large as possible of the flat tubes.

The longitudinal axis of the exhaust channel of the fans and the horizontal coordinate axis which both span a vertical plane, form an angle that in particular is between 0 and 45. The longitudinal axis of the exhaust channel of the fans on this vertical plane is offset in the direction of the center of the one or more evaporators or the one or more heat exchangers.

The distance between the exhaust opening of the fans and the heat exchanger or the evaporator, respectively, is more than 3 cm, in particular approximately 5 cm, and preferably approximately 10 cm, in order to achieve a better homogenization of the discharged air.

In a different preferred embodiment, it is provided that the fans are not arranged in close vicinity to the one ore more evaporators and/or the one or more heat exchangers. Rather, with the aid of a tube-shaped connecting element that is coupled to the fans and to the one or more evaporators and/or the one ore more heat exchangers in a sealed manner, the fans are separately incorporated therein.

The separate configuration is especially favorable if the dimensions of the inventive air conditioning unit at a desired mounting location of a machine do not fit. Then it is possible to change the configuration of the inventive module accordingly, in particular with the aid of the fans that are separated from the heat exchanger and/or evaporator.

In a preferred embodiment, the module is connectable to an adapter element with connectors for hoses, flaps and nozzles, for example. The adapter element is approximately as long and as high as the one or more heat exchangers and/or the one or more evaporators and, in particular, has a width or thickness of 100 mm to 180 mm.

In the module according to the present invention, a motor for driving the fans for the one or more evaporators and/or the one or more heat exchangers is provided. In one preferred embodiment, the fans and said motor are arranged on top of each other in particular due to the spatial limits of the module. The mounting of the motor is reinforced in a manner known per se, such that during operation of the machine, the motor is also able to sustain high vertical accelerations.

It is provided that the one or more heat exchanger and/or evaporators comprises plate fins on at least one radiator tank, wherein the plate fins are arranged between the flat tubes and are connected therewith in a heat-conducting manner, and the one or more radiator tanks are disposed relative to the flat tubes and/or the plate fins in a vertically upright manner.

The interconnections between the flat tubes and the plate fins, between the flat tubes and the one or more radiator tanks according to the invention are soldered using the one-shot brazing technology. The term “one-shot brazing technology” refers to a technique during which all or many interconnections of a device are soldered at the same time in one soldering cycle.

The corresponding process proceeds as follows:

All components to be soldered at first are connected with one another in a manner known per se. At the interconnections between the components solders are arranged in a manner known per se. Subsequently, this configuration or arrangement, respectively, is introduced in a special soldering furnace in order to provide the corresponding interconnections. Among other things, it is advantageous that no further fastening elements or hard soldering, etc., is required during or after the one-shot brazing process.

Due to the fact that the one-shot brazing process usually is not performed by trained soldering staff but by a special soldering furnace semi-automatically, a reliable or safe soldering result is ensured, compared to possible unintended mishandlings, and further a good performance, pressure resistance and tightness of the heat exchanger is ensured.

In the case of manual soldering, the soldering worker may perhaps forget to solder some of the interconnections between the plate fins and the flat tubes and between the flat tubes and the radiator tank, each resulting in a deterioration of the heat conduction between the plate fins and the flat tubes, and as the case may be, even in the leakage of the water at non-soldered interconnections between the flat tubes and the radiator tank.

The soldering worker, after previous soldering a work piece at a soldering temperature of the soldering gun higher than the melting point of the aluminum, may inadvertently have set the soldering temperature incorrectly, resulting in the possible melting of the flat tubes made from aluminum and then in leaking out of refrigerant agent or water.

Moreover, the one-shot brazing process is timesaving because the required soldering time in one-shot brazing—only one soldering cycle—is significantly shorter relative to the normal soldering process.

Furthermore, the one-shot brazing soldering process also offers economical advantageous. A trained solder technician is not required for handling the soldering furnace. Only a worker who is able to enter parameters into the soldering furnace, is required.

According to the invention it is provided that the flat tubes are manufactured using extrusion-molding technology. It is preferred that according to the invention at least one ridge is provided within the flat tube of the heat exchanger, which ridge divides the inner space of the flat tube into so-called “microchannels”.

The ridge according to the invention significantly increases the pressure resistance of the flat tubes such that they can sustain more than 3.5 bar, preferably about 6 bar, whereas the pressure resistance of a standard tube without a structure of this kind only amounts to 1.5 to 2 bar.

Further, according to the invention, this ridge enlarges the contact surface of the flat tubes with (heating) water such that the heat exchange performance of the heat exchanger of the inventive air conditioning unit is further enhanced.

Preferably, the thickness or width, respectively, of the ridge in the horizontal plane is about one tenth ( 1/10), in particular about one seventh ( 1/7) of the thickness of the flat tube in order to achieve a better resistance to the tensile stress of water.

It is particularly preferred that the ridge extends at given positions across the entire length of the extruded sections between the upper wall and the lower wall of the flat tubes in order for the ridge to be able to act against the bending stress on the longitudinal side of flat tube in the vertical plane; the ridge acts as a reinforcement against bending stress.

In order to further increase the contact surface of the flat tubes with water, the flat tubes, according to the invention, may comprise profiles that are in parallel to the height of the flat tubes. The height of these profiles amounts to one third (⅓), preferably one fourth (¼) of the height of the flat tubes.

According to the invention it is provided that the distance between two flat tubes arranged on top of each other is less than 8 cm, in particular less than 5 cm, preferably less than 3 cm, in order to homogenize the temperature of the air that flows through the plate fins.

For a further reduction of the weight of the inventive air conditioning unit, the housing of the module consists of expanded polypropylene (EPP).

In a further embodiment it is provided that neither an evaporator nor a corresponding condensed water tank are provided in the inventive module. In this case, the module only serves as a heating.

### BRIEF DESCRIPTION OF THE DRAWINGS

Further advantages, details and features arise from the following description of exemplary embodiments of the invention with respect to the drawings, in which:

FIG. 1 shows a schematically illustrated embodiment of the inventive air conditioning unit comprising an adapter element;

FIG. 2 shows a side view of the embodiment of the inventive air conditioning unit according to FIG. 1;

FIG. 3 shows a different schematically illustrated embodiment of the inventive air conditioner comprising a flap unit;

FIG. 4 shows a side view of the embodiment of the inventive air conditioning unit according to FIG. 3;

FIG. 5 shows a schematically illustrated evaporator having two condensed water tanks, of an embodiment of the inventive air conditioning unit in the side view;

FIG. 6 shows a schematically illustrated evaporator comprising a flap and a condensed water tank arranged at the flap, of an embodiment of the inventive air conditioner in the side view;

FIG. 7A shows a schematic view of the heat exchanger of the embodiment according to FIG. 1;

FIG. 7B shows a schematic view of an enlarged selected part of the heat exchanger according to FIG. 7A;

FIG. 7C shows a schematic front view of an enlarged flat tube of the heat exchanger according to FIG. 7A; and

FIG. 8 shows a schematically illustrated embodiment comprising fans that are separated from the one or more heat exchangers or the one or more evaporators, respectively.

### DETAILED DESCRIPTION OF THE PREFERRED EMBODIMENTS

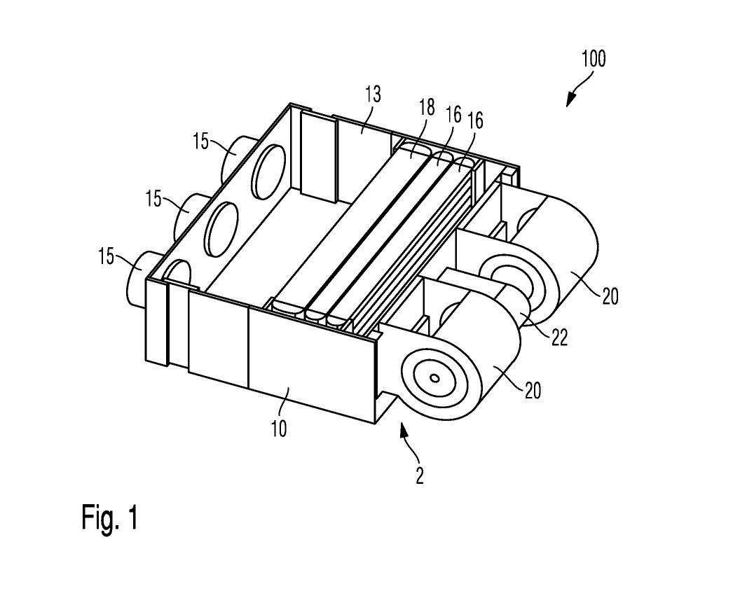

The embodiment illustrated in FIG. 1 of the inventive air conditioning unit 100 comprises inter alia one compressor, one expansion valve, two evaporators 16, one heat exchanger 18, two fans 20 for the evaporators (16) and/or the heat exchanger 18, one motor 22 for driving those fans 20, two condensed water tanks (not illustrated in FIG. 1) and one housing 10 for the accommodation of all components of the air conditioning unit 100.

The heat exchanger 18, the evaporators 16, two condensed water tanks and the fans 20 with the motor 22 that inventively form one module 2, are surrounded by one housing (not illustrated in FIG. 1).

In the illustrated embodiment according to FIG. 1, an adapter element 13 with three connecting pieces for three hoses 15 is coupled to the module 2, through which the air escaping from the heat exchanger 18 and/or the evaporator 16 is distributed. The adapter element 13 is approximately as long and as high as the heat exchanger 18 and/or the evaporators 16 and has a thickness 3 reaching from 100 mm to 180 mm.

This thickness amounts to approximately four times to approximately six times the thickness/width of the heat exchanger 18 so that the air resistance is not undesirably too large due to hoses 15 too closely arranged or other air distribution elements such as nozzles or flaps. In order to reduce the weight of the inventive air conditioning unit 100, the housing of the module 2 consists of expanded polypropylene (EPP).

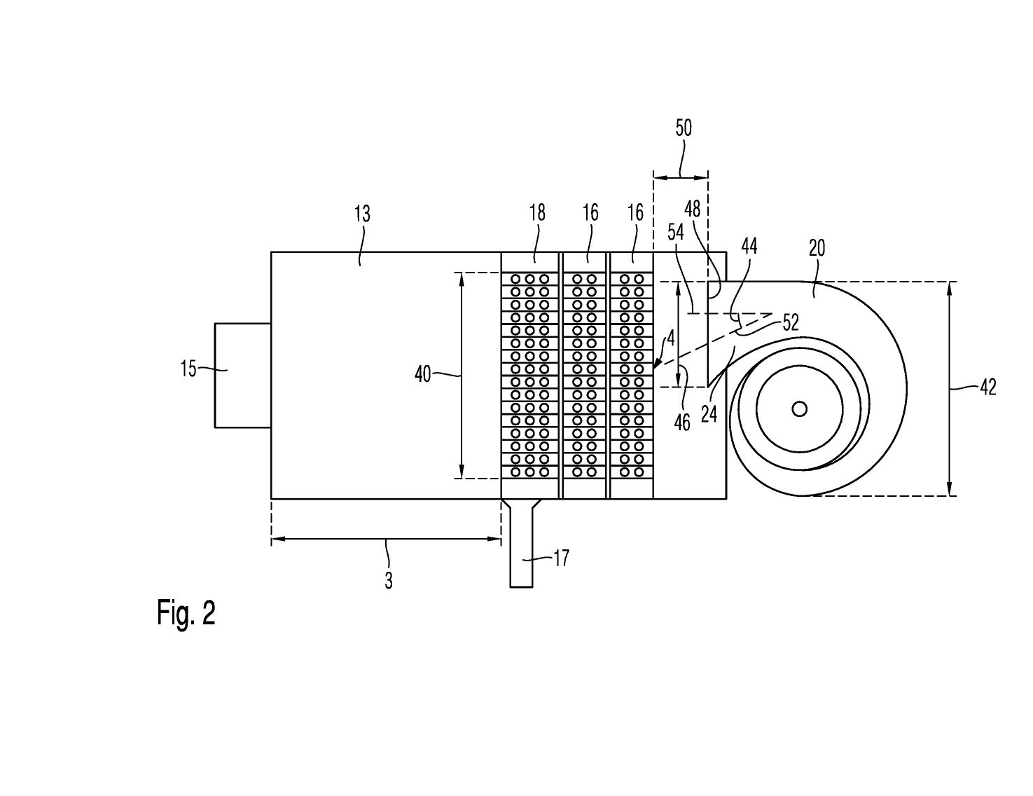

According to FIG. 2, the height 40 of the heat exchanger 18 and the height of the evaporator 16 are approximately the same and about 20% larger than the height 42 of the fans 20. The fans 20 each comprise one exhaust channel 24 having an exhaust opening 48. The height 46 of this exhaust opening 48 according to FIG. 2 is approximately ½ of the height 40 of the evaporators 16 and/or the heat exchanger 18.

According to FIG. 2, the cross-sectional area of the exhaust channel 24 in the illustrated plane is enlarged in the direction towards the exhaust opening 48 in a manner known per se. However, it is preferred to increase the cross-sectional area of the exhaust channel 24 in all planes in the direction towards the exhaust opening so that the exhausted or discharged air flows through an area as large as possible of the tubes of the evaporators 16 and/or the heat exchanger 18.

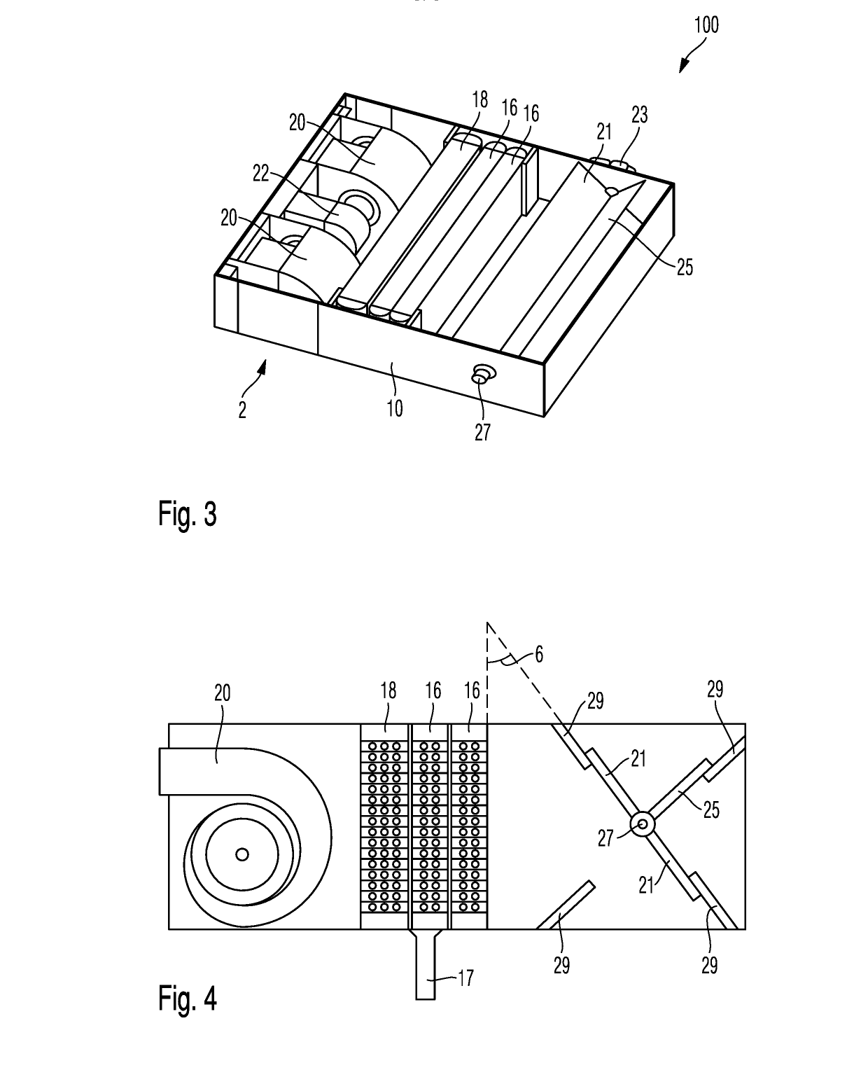

The longitudinal axis 52 of the exhaust channel 24 and the horizontal coordinate axis 54 in the plane illustrated in FIG. 3 form an angle 44 that in particular is between 0 and 45.

The longitudinal axis 52 of the exhaust channel 24 of the fans 20 on this vertical plane is offset in the direction of the center 4 of the evaporators 16 or the heat exchanger. The distance 50 between the exhaust opening 48 of the fans 20 and the closer evaporator 16 is more than 3 cm, in particular about 5 cm, preferably about 10 cm, in order to achieve a better homogenization of the exhausted or discharged air.

According to FIG. 3, a flap unit is provided that inter alia comprises a rotatable flap 21, a ridge 25 for stiffening or reinforcing the flap 21, and a motor 23 for operating the flap 21, is coupled to the module 2 of the inventive air conditioning unit in order to switch the air flow between fresh air and circulated air.

In this embodiment the heat exchanger 18 and the evaporators 16 are arranged in the direction of the airflow between the fans 20 and the flap 21. In this case, the fans 20 suck or draw in the air that flows through the evaporators 16 and/or the heat exchanger 18 and give it off to air distribution elements.

The flap 21 has about the same length than the heat exchanger 18 or the evaporator 16. The ridge 25 extends along the longitudinal axis of the longitudinal side of the flap 21 approximately perpendicular to the flap 21 and is connected therewith. The ridge 25 has approximately the same length and half the width of the flap 21.

According to FIG. 4, the longitudinal side of the flap 21 forms an angle 6 with the air intake side of the closer evaporator 16. The angle 6 is between 30 and 60, in particular.

The flap 21 is operated by the motor 23 and rotates about the axis 27. By means of the four stops 29 that consist of a material having a good elasticity, the flap 21 is safely kept in the positions for fresh air or circulated air, respectively, and by means of the ridge 25, the flap 21 is reinforced.

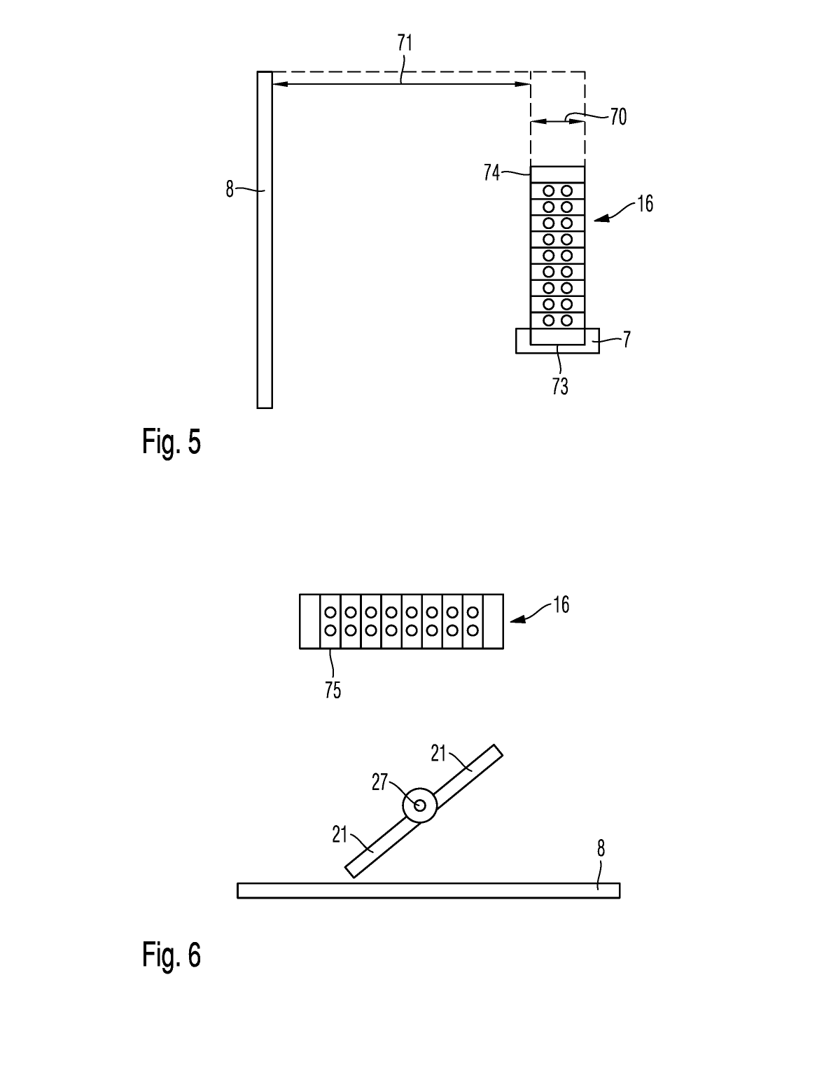

In the embodiment according to FIG. 5, provided two condensed water tanks 7 and 8 are provided for collecting the condensed water from the evaporator 16. The two condensed water tanks 7 and 8 are arranged transversely relative to one another and each collects the condensed water at the respective vertically mounted inventive air conditioning unit (as illustrated in FIG. 5) or the horizontally mounted inventive air conditioning unit.

According to FIG. 5, the condensed water tank 7 is arranged just below the evaporator 16. The area of the condensed water tank 7 is slightly larger than the area of the closed side 73 of the evaporator 16.

The condensed water tank 8 is arranged at the air outflow side 74 of the evaporator 14 with a gap 71 thereto. The gap 71 is about three times to about five times the width/thickness 70 of the evaporator so that the air resistance is not undesirably too large due to a condensed water tank 8 that is arranged too close. The area of the condensed water tank is significantly larger than that of the air outflow side 74 of the evaporator 16. This ensures that the entire condensed water may be collected by the larger condensed water tank 8, although with a relatively large gap 71 relative to the condensed water tank 8.

In another embodiment according to FIG. 6, the inventive air conditioning unit is mounted horizontally. A condensed water tank 8 that has a significantly larger area than the air intake side 75 of the evaporator 16 is arranged beneath the flap 21. This ensures that the entire condensed water can be collected.

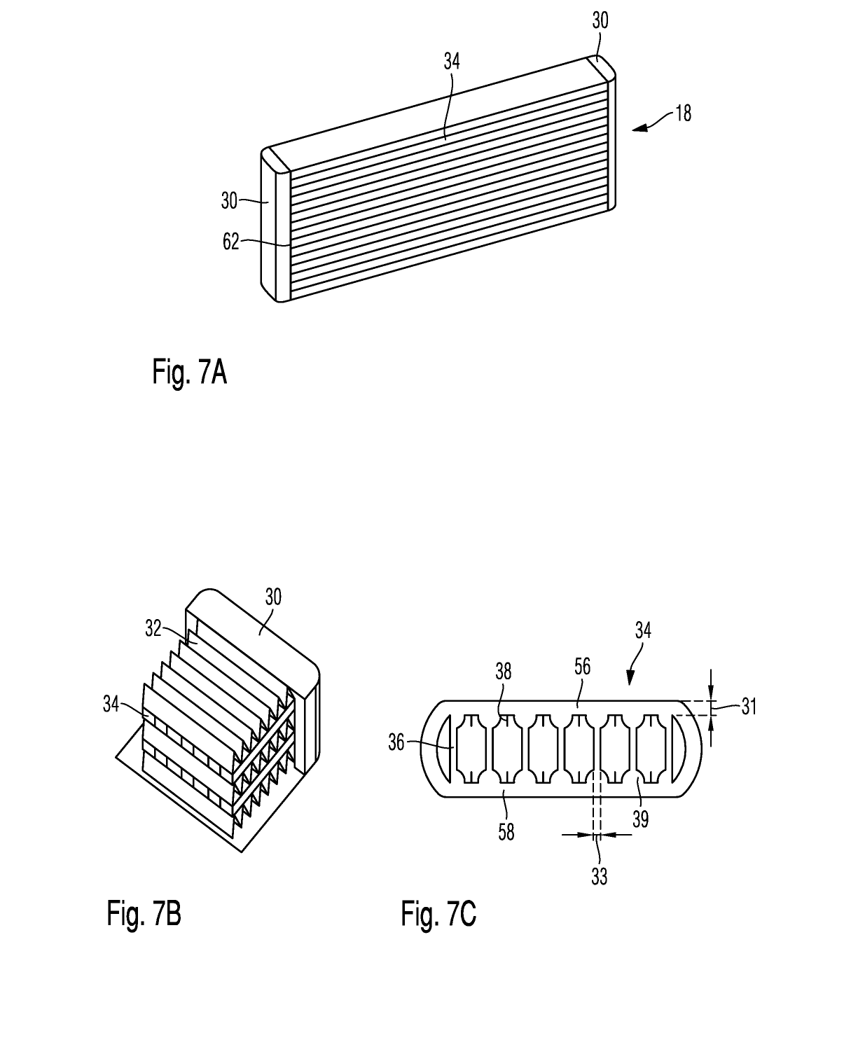

According to FIG. 7A and FIG. 7B the heat exchanger 18 comprises a plurality of flat tubes 34, plate fins 32 and at both ends of the heat exchanger 18 one radiator tank 30 each in the longitudinal direction. Due to the higher performance density of flat tubes, the inventive air conditioning unit 100 may be built lighter and smaller than an air conditioning unit with round tubes while offering the same performance.

The flat tubes 34 and the plate fins 32 of the heat exchanger 18 consist of light metal, preferably aluminum, instead of copper and thus also reduce the total weight.

According to the invention, it is provided that the interconnections between the flat tubes 34 and the plate fins 32 and between the flat tubes 32 and the radiator tank 30 are soldered using the one-shot brazing technology. As a result, numerous advantages are achieved, as described above.

According to the invention it is further provided that the flat tubes 34 are produced using extrusion technology. It is preferred that according to FIG. 7C a plurality of ridges 36 is provided in the flat tube 34 of the heat exchanger 18. Those ridges 36 divide the interior of the flat tube 34 into so-called “microchannels”.

The ridges 36, on the one hand, significantly increase the pressure resistance of the flat tubes 34 so that they can bear more than 3.5 bar, preferably about 6 bar. On the other hand, according to the invention, the ridges 36 enlarge the contact surface of the flat tubes 34 with (heating) water so that the heat exchange performance of the heat exchanger 18 is further increased.

In a preferred embodiment, the thickness or width 33 of the ridges 36 is about one tenth ( 1/10), in particular about one seventh ( 1/7) of the thickness 31 of the flat tube 34 for achieving a better resistance to the tensile strength resulting from the internal pressure in the horizontal plane.

In a particularly preferred embodiment, the ridges 36 extend at given positions (one of these positions is indicated in FIG. 7C with reference numeral 39) across the entire length of the extruded sections between the upper wall 56 and the lower wall 58 of the flat tubes 34, so that the ridges 36 can also act on the longitudinal sides of the flat tubes 34 in the vertical plane against bending stress.

In a particularly preferred embodiment, the flat tubes 34 comprise the profiles 38 in parallel to the flat tube height in order to further increase the contact surface of the flat tubes 34 with water.

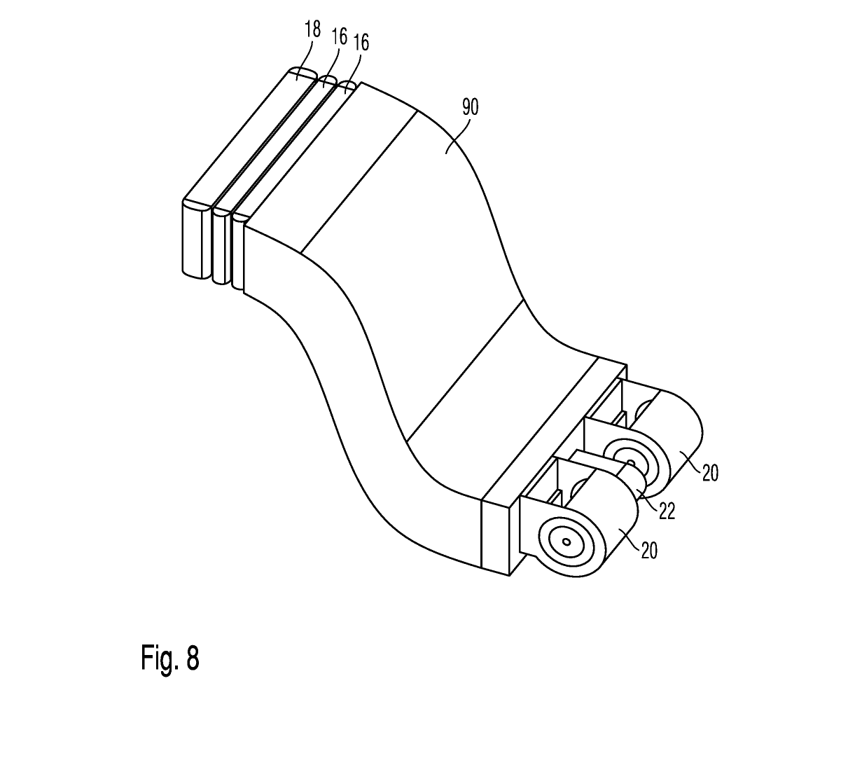

FIG. 8 shows a further embodiment of the inventive air conditioning unit, wherein the fans 20 are arranged separately from the evaporators 16 and the heat exchanger 18 with the aid of a tube-shaped connecting element 90. The connecting pieces of the connecting element 90 to the evaporators 16 and the fans 20 are provided in a sealed manner.

The separate configuration is especially favorable if the dimensions of the inventive air conditioning unit do not fit at a desired mounting position of a machine. Then, the configuration or design of the inventive module 2 can be altered in order to adapt to all cases, in particular by means of the fans 20 that are arranged separately from the heat exchanger 18 and/or the evaporators 16.

The specification incorporates by reference the disclosure of DE 10 2015 113 544.2, filed Aug. 17, 2015.

The present invention is, of course, in no way restricted to the specific disclosure of the specification and drawings, but also encompasses any modifications within the scope of the appended claims.

We claim:

1. An air conditioning unit, comprising:
at least one evaporator;
at least one heat exchanger;
a plurality of fans for the at least one evaporator and the at least one heat exchanger;
at least one compressor;
at least one expansion valve;
at least one condensed water tank;
at least one housing for accommodating said fans, said at least one evaporator, said at least one heat exchanger, said at least one compressor, said at least one expansion valves, and/or said at least one condensed water tanks;
wherein the one or more evaporators (16) and the one or more heat exchangers (18) comprise flat tubes (34) made of a lightweight metal, and
wherein at least one of the at least one heat exchangers (18), at least one of the at least one evaporator (16), at least two of the at least one condensed water tank (7, 8) and at least one of the fans (20) for the one or more evaporators (16) and/or heat exchangers (18) together form a module (2) and are surrounded by one of the at least one housing, wherein said at least two condensed water tanks (7, 8) are arranged in transverse alignment to one another in the module in order to collect condensed water in adaptation to various mounting positions of the module (2),
wherein the compressor and/or the expansion valve or the compressors and/or expansion valves, respectively, are interchangeable to adapt to selected performance requirements of the at least one evaporator (16), and wherein performance of the at least one fan (20) is adaptable to the selected performance requirements of the at least one evaporator (16) or the at least one fan (20) is interchangeable with other fans(20).

2. The air conditioning unit according to claim 1, wherein the lightweight metal is aluminum.

3. The air conditioning unit according to claim 1, wherein the flat tubes (34) are fabricated using extrusion technology.

4. The air conditioning unit according to claim 1, wherein the mounting positions of the module are selectively positionable horizontally and vertically.

5. The air conditioning unit according to claim 1, wherein the at least one heat exchangers (18) and/or evaporators (16) comprise plate fins (32) and at least one radiator tank (30), wherein the interconnections between the flat tubes (34) and the plate fins (32), between the flat tubes (34) and the one or more radiator tanks (30) are soldered using one-shot brazing technology, wherein all or many interconnections of a device are soldered simultaneously in one soldering cycle.

6. The air conditioning unit according to claim 1, wherein the one or more heat exchangers (18) comprise plate fins (32) and at least one radiator tank (30), wherein the plate fins (32) are disposed between the flat tubes (34) and are connected therewith in a heat-conducting manner, and wherein the one or more radiator tanks (30) are disposed relative to the flat tubes (34) and/or the plate fins (32) in a vertically upright manner.

7. The air conditioning unit according to claim 1, wherein the at least one heat exchanger (18) and the at least one evaporator (16) are arranged within the housing of the module (2), wherein air intake sides (75) of the at least one heat exchanger (18) and the at least one evaporators (16) extend parallel to one another, wherein a height (40) of the at least one heat exchanger (18) and a height of the at least one evaporator (16) are approximately equal and approximately 20% larger than a height (42) of the fan for the at least one evaporator and/or at least one heat exchanger.

8. The air conditioning unit according to claim 1, further comprising at least one rotatable flap (21) that is driven by a motor (23), wherein said at least one rotatable flap (21) is disposed on the module (2), wherein said at least one rotatable flap is configured to switch an air flow between fresh air and recirculating air.

9. The air conditioning unit according to claim 8, wherein at least one rotatable flap (21) has approximately the same length as the at least one heat exchanger (18) or the at least one evaporator (16).

10. The air conditioning unit according to claim 8, wherein a longitudinal side of the at least one flap (21) in case of the fresh air or recirculating air forms an angle (6) with the air intake side (75) of the at least one heat exchanger (18) or the at least one evaporators (16).

11. The air conditioning unit according to claim 10, wherein the angle is between 30° and 60°.

12. The air conditioning unit according to claim 8, wherein at least one ridge (25) extends along a longitudinal axis of a longitudinal side of the at least one rotatable flap (21) approximately perpendicular to the at least one flap (21) and is connected therewith, wherein the ridge (25) is approximately as long as and half as wide as the at least one flap (21).

13. The air conditioning unit according to claim 1, wherein within the module (2), at least one of the condensed water tanks (7) is arranged at a front face and/or a closed side (73) of the at least one evaporator (16), wherein the area of the at least one condensed water tank (7) is larger than an area of the front face and/or the closed side (73) of the at least one evaporator (16).

14. The air conditioning unit according to claim 1, wherein at least one of the condensed water tanks (8) is disposed at a distance (71) from an air intake side (74) of the at least one evaporator (16) within the module (2), which the distance (74) is three to five times a width (70) of the at least one evaporator (16), wherein an area of the at least one condensed water tank (8) is substantially larger than an area of air outflow or outtake side (74) of the one ore more evaporators (16).

15. The air conditioning unit according to claim 8, wherein at least one condensed water tank (8) is disposed proximate the at least one rotatable flap (21), wherein the one or more flaps (21) are arranged between the one or more evaporators (16) or the one or more heat exchangers (16) and the one ore more condensed water tanks (8), and wherein an area of the at least one condensed water tanks (8) is substantially larger than an area of the air intake side (75) of the at least one evaporator (16) or the at least one heat exchanger (18).

16. The air conditioning unit according to claim 8, wherein the fans (20) for the one or more evaporators (16) and/or the one ore more heat exchangers (18) is disposed in the direction of air flow between the at least one evaporator (16) or the at least one heat exchanger (18) and the at least one rotatable flap (21),
wherein each of said fans include an exhaust channel with an exhaust opening (48), wherein a height (46) of the exhaust opening (48) of the exhaust channel is approximately ⅔ of the at least one evaporator (16) or the at least one heat exchanger (18), and
wherein a cross-sectional area of the exhaust channel (24) of the fans (20) becomes larger in the direction of the exhaust opening (48), and
wherein a longitudinal axis (52) of the exhaust channel (24) of the fans (20) and a horizontal coordinate axis (54) which both span a vertical plane form an angle (44) between 0° and 45°, and
wherein the longitudinal axis (52) of the exhaust channel (24) of the fans (20) is offset on said vertical plane in a direction of a center (4) of the at least one evaporator (16) or the at least one heat exchanger (18).

17. The air conditioning unit according to claim 16, wherein the height (46) of the exhaust opening (48) of the exhaust channel is approximately half a height (4) of the at least one evaporator (16) or the at least one heat exchanger (18).

18. The air conditioning unit according to claim 1, wherein the at least one heat exchanger (18) or the at least one evaporator (16) are arranged in the direction of the airflow between the fans (20) for the at least one evaporator (16) and/or the at least one heat exchanger (18) and the at least one rotatable flap (21).

19. The air conditioning unit according to claim 1, wherein the module (2) is connectable to an adapter element (13) with connectors (15) for hoses, flaps and nozzles, wherein the adapter element has approximately the same height and length as the at least one heat exchanger (18) and/or the at least one evaporator (16).

20. The air conditioning unit according to claim 19, wherein the adapter element has a width (3) of 100 mm to 180 mm.

21. The air conditioning unit according to claim 1, wherein a motor (22) for driving the fans (20) for the at least one evaporator (16) and/or the at least one heat exchanger (18) is provided at the fans (20) within the module (2), wherein said fan (20) und said motor (22) are arranged on top of each other, and wherein the mounting of said motor (22) is adjusted to said arrangement.

22. The air conditioning unit according to claim 8, wherein an air intake case is provided at the module (2) und is connected to the module in a sealed manner via a flange, wherein the air intake case comprises at least two sockets or flanges that are each arranged approximately at a center of an area of the air intake case, and wherein said intake system for recirculating air or fresh air is connectable via said sockets or flanges.

23. The air conditioning unit according to claim 22, wherein the at least one rotatable flap (21) is arranged within the air intake case.

24. The air conditioning unit according to claim 1, further comprising at least one tube-shaped connecting element (90) coupled to the fans (20) and to the at least one evaporator (16) and/or the at least one heat exchanger (18) in a sealed manner, such that the fans (20) are separately incorporated therein.

25. The air conditioning unit according to claim 1, wherein the at least one evaporator (16) and/or the at least one heat exchanger (18) is exchangeable with a smaller evaporator (16) and/or heat exchanger in the module (2) depending on smaller power requirements, wherein the smaller evaporator (16) and/or heat exchanger (18) has an equal height and width as compared to the exchanged evaporator (16) and/or heat exchanger (18), and further has a shorter length than the exchanged evaporator (16) and/or heat exchanger (18).

26. The air conditioning unit according to claim 1, wherein at least one of the heat exchangers (18) and at least one of the fans (20) for the at least one heat exchanger (18) are surrounded by one of said housings together as one module (2).
